(19) United States
(12) Patent Application Publication
(10) Pub. No.: US 2011/0133623 A1
(43) Pub. Date: Jun. 9, 2011

(54) LIGHT EMITTING DIODE LAMP

(75) Inventors: Shao-Nong TSAI, Bade City (TW); Chun-Ta Yeh, Chang-Hua City (TW)

(73) Assignee: PROLYNN TECHNOLOGY, INC.

(21) Appl. No.: 12/959,181

(22) Filed: Dec. 2, 2010

(30) Foreign Application Priority Data
Dec. 4, 2009 (TW) 098141525

(51) Int. Cl. H01J 61/52

(52) U.S. Cl. 313/46

(57) ABSTRACT

A light emitting diode lamp comprises: a heat dissipating assembly including a column unit and a coolant container, the column unit defining opposite first and second fluid passages separated from each other, the coolant container defining a coolant storing space for storing a coolant therein; a heat sink mounted on the heat dissipating assembly and defining a fluid channel therein; a light emitting unit including at least one light emitting diode and mounted on the heat sink; and a coolant driving member. The coolant driving member, the heat sink, the coolant container and the column unit are coupled together so that the coolant driving member drives circulation of the coolant through the first and second fluid passages, the coolant storing space and the fluid channel.

### CROSS-REFERENCE TO RELATED APPLICATION

This application claims priority of ROC Application No. 98141525, filed on Dec. 4, 2009.

### BACKGROUND OF THE INVENTION

1. Field of the Invention

The invention relates to a light emitting diode lamp, more particularly to a light emitting diode lamp with a liquid cooling system.

2. Description of the Related Art

Light emitting diodes (LEDs) have been used in various applications due to advantages, such as small size, high resistance to impact, long serving life, low power consumption, etc. It has been known in the art that light emitting diodes of an LED lamp can generate a sufficient amount of heat that can reduce the efficiency and serving life of the light emitting diodes. Hence, there is a need to improve the heat dissipation of the light emitting diodes.

FIG. 1 illustrates a conventional LED lamp that includes a metal plate 11, an array of light emitting diodes 12 mounted on the metal plate 11, and a heat sink 13 attached to the metal plate 11 and formed with a plurality of heat dissipating fins 131 for dissipating heat generated from the light emitting diodes 12. However, the efficiency of transferring the heat from the metal plate 11 to the heat sink 13 is relatively low, which can cause the LED lamp to have a high center of gravity that decreases stability.

U.S. Patent Application Publication No. 2008/0069706 discloses a centrifugal pump device for a heat dissipation system. The centrifugal pump device can be attached to a CPU to drive a liquid coolant that carries away heat generated by the CPU. The centrifugal pump device is formed with a pump chamber, an inlet passage, an outlet passage, and a spiral liquid passage in a pump housing unit that is made from a thermally conductive material. The inlet passage is in fluid communication with the spiral liquid passage. The outlet passage is in fluid communication with the pump chamber. The spiral liquid passage is in fluid communication with the pump chamber through a plurality of orifices formed in the pump housing unit. The centrifugal pump device drives the liquid coolant to flow through the spiral liquid passage to carry away the heat generated by the CPU. The whole disclosure of the U.S. Patent Application Publication No. 2008/0069706 is incorporated herein by reference.

### SUMMARY OF THE INVENTION

Therefore, the object of the present invention is to provide a light emitting diode lamp that can overcome at least one of the aforesaid drawbacks associated with the prior art.

Accordingly, there is provided a light emitting diode lamp that comprises: a heat dissipating assembly including a column unit and a coolant container connected to the column unit, the column unit being made from a thermally conductive material for heat dissipation and defining opposite first and second fluid passages separated from each other, the coolant container defining a coolant storing space for storing a coolant therein; a heat sink mounted on the heat dissipating assembly and defining a fluid channel therein; a light emitting unit including at least one light emitting diode and mounted on the heat sink so that the heat sink can carry away the heat generated from the light emitting diode; and a coolant driving member. The coolant driving member, the heat sink, the coolant container and the column unit are coupled together so that the coolant driving member drives circulation of the coolant through the first and second fluid passages, the coolant storing space and the fluid channel so as to transfer the heat from the heat sink to the column unit through the circulated coolant.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional LED lamp;

FIG. 2 is a fragmentary perspective view of the first preferred embodiment of an LED lamp according to the present invention;

FIG. 3 is a fragmentary perspective view of an assembly of a column unit, a heat sink and a coolant container of the first preferred embodiment;

FIG. 4 is a fragmentary perspective view of a column unit of the second preferred embodiment according to the present invention;

FIG. 5 is a fragmentary perspective view of a column unit of the third preferred embodiment according to the present invention;

FIG. 6 is a fragmentary perspective view of the fourth preferred embodiment according to the present invention;

FIG. 7 is a fragmentary perspective view of an assembly of a column unit, a heat sink, a coolant driving member, and a coolant container of the fifth preferred embodiment according to the present invention;

FIG. 8 is an exploded perspective view of an assembly of the heat sink and the coolant driving member of the fifth preferred embodiment;

FIG. 9 is a fragmentary perspective view of the sixth preferred embodiment according to the present invention, illustrating an assembly of a column unit, a heat sink and a coolant container disposed at a vertical position; and

FIG. 10 is a fragmentary perspective view of the sixth preferred embodiment, illustrating the assembly of the column unit, the heat sink and the coolant container disposed at a horizontal position.

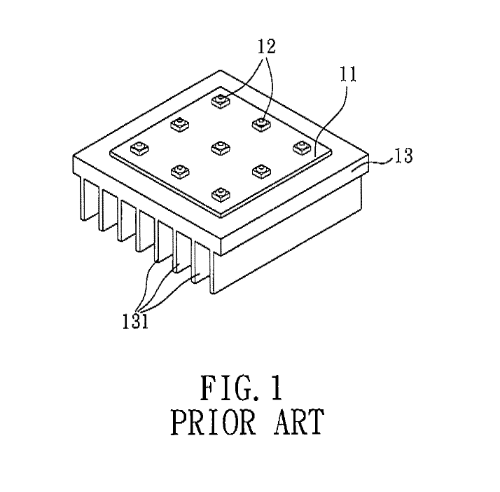

### DETAILED DESCRIPTION OF THE PREFERRED EMBODIMENTS

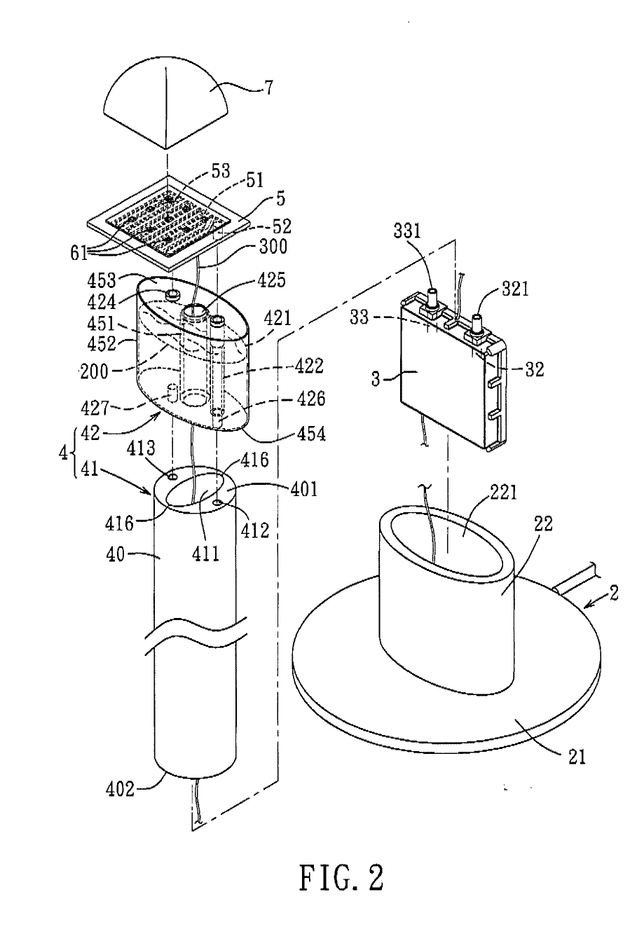

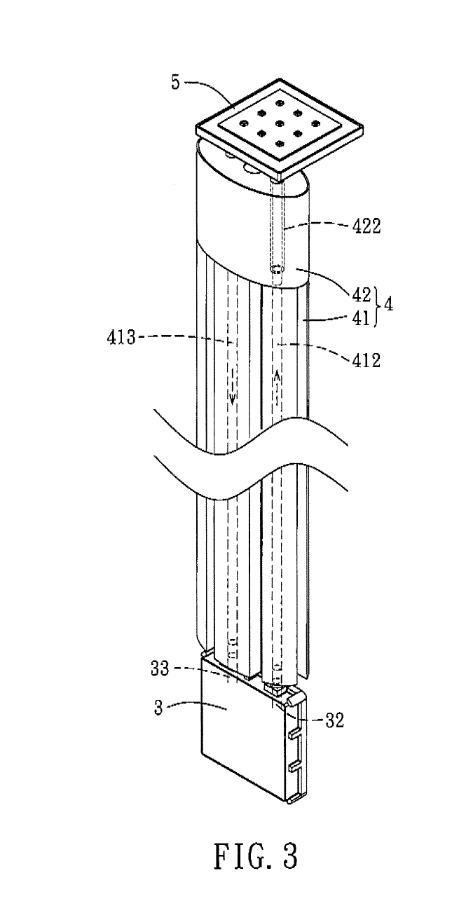

Referring to FIGS. 2 and 3, the first preferred embodiment of an LED lamp according to the present invention is shown to include: a base 2 having a base plate 21 and a mounting part 22 protruding upwardly from the base plate 21 and defining a receiving space 221; a heat dissipating assembly 4 including a column unit 41 and a coolant container 42 connected to the column unit 41, the column unit 41 being made from a thermally conductive material for heat dissipation and defining opposite first and second fluid passages 412, 413 separated from each other and extending along the length of the column unit 41, the coolant container 42 defining a coolant storing space 421 for storing a coolant 200 therein; a heat sink 5 mounted on the heat dissipating assembly 4 and defining a multi turn fluid channel 51 therein; a light emitting unit including at least one light emitting diode 61 (an array of the light emitting diodes is provided in this embodiment) and mounted on the heat sink 5 so that the heat sink 5 can carry away the heat generated from the light emitting diode 61; a first coolant driving member 3 received securely in the receiving space 221 in the mounting part 22; and a shade cover 7 mounted on the heat sink 5 for covering the light emitting diodes 61. The first coolant driving member 3, the heat sink 5, the coolant container 42 and the column unit 41 are coupled together so that the first coolant driving member 3 drives circulation of the coolant 200 through the first and second fluid passages 412, 413, the coolant storing space 421 and the fluid channel 51 so as to transfer the heat from the heat sink 5 to the column unit 41 through the circulated coolant 200.

In this embodiment, the column unit 41 serves as a stand for supporting the heat sink 5, and includes a column that has a hollow wall body 40 having first and second ends 401, 402 and defining a central hole 411 extending along the length of the hollow wall body 40 through the first and second ends 401, 402 of the hollow wall body 40. The hollow wall body 40 is cylindrical in shape. The first and second fluid passages 412, 413 are formed in the hollow wall body 40 and extend along the length of the hollow wall body 40 through the first and second ends 401, 402 of the hollow wall body 40. The central hole 411 is disposed between the first and second fluid passages 412, 413, and is substantially oval in shape such that the hollow wall body 40 has two thin wall portions 416, each of which has a thin thickness, and two thick wall portions that define the first and second fluid passages 412, 413, respectively. Due to the presence of the thin wall portions 416, heat conduction between the two thick wall portions may be slowed down. Thus, heat transfer between the coolant 200 passing through the first passage 412 and the coolant 200 passing through the second fluid passage 413 may be reduced.

Although each of the first and second fluid passages 412, 413 are straight passages in this embodiment, it can be configured to extend along a meandering line or a multi-turn line to enhance heat dissipation efficiency.

The coolant container 42 has an inner surrounding wall 451 defining a central through-hole 425, an outer surrounding wall 452 spaced apart from and surrounding the inner surrounding wall 451, and top and bottom walls 453, 454 interconnecting the inner and outer surrounding walls 451, 452. The inner and outer surrounding walls 451, 452 cooperate with the top and bottom walls 453, 454 to define the coolant storing space 421.

The heat sink 5 is disposed above the column unit 41, and the coolant container 42 is disposed between the heat sink 5 and the column unit 41. A connecting pipe 422 extends into and through the coolant storing space 421 and is connected directly to the fluid channel 51 in the heat sink 5 and the first fluid passage 412 in the column unit 41 so that the fluid channel 51 in the heat sink 5 is in fluid communication with the first fluid passage 412 through the connecting pipe 422.

Disposing the coolant container 42 above the column unit 41 and forming the first and second fluid passages 412, 413 in the column unit 41 has an advantage that when any bubbles are formed in the coolant 200 in the coolant container 42 or carried into the first and second fluid passages 412, 413, the bubbles can have enough time to diminish in the coolant container 42 or in the first and second fluid passages 412, 913 before entering the fluid channel 51. The presence of the air bubbles in the coolant 200 can reduce the effect of the coolant 200 in the fluid channel 51 for cooling the heat sink 5. The first coolant driving member 3 is preferably a centrifugal pump, is disposed below the column unit 41 and has a discharging port 32 and a suction port 33 which are in fluid communication with the first and second fluid passages 412, 413, respectively, to withdraw the coolant 200 from the coolant container 42 via the second fluid passage 413 into the suction port 33 and to discharge the coolant 200 from the discharging port 32 into the fluid channel 51 via the first fluid passage 412 and the connecting pipe 422.

A connecting tube assembly is used to connect the column unit 41, the coolant container 42, the heat sink 5 and the first coolant driving member 3, and includes a discharging tube 321 extending from a periphery of the discharging port 32 into the first fluid passage 412, a suction tube 331 extending from a periphery of the suction port 33 into the second fluid passage 413, a first connecting tube 426 extending from the connecting pipe 422 into the first fluid passage 412, a second connecting tube 427 extending from a bottom hole in the bottom wall 454 of the coolant container 42 into the second fluid passage 413, an inlet tube 52 extending from one end of the fluid channel 51 in the heat sink 5 into the connecting pipe 422, and an outlet tube 53 extending from the other end of the fluid channel 51 in the heat sink 5, through a top hole 424 in the top wall 453 of the coolant container 92 and into the coolant storing space 421. Hence, the connecting tube assembly, the heat sink 5, the coolant container 42, the column unit 41 and the first coolant driving member 3 can be coupled together, and a flow circulation path can be established that passes through the fluid channel 51, the coolant storing space 421, the first and second fluid passages 412, 413, and the first coolant driving member 3.

A power line 300 is electrically connected to the light emitting diodes 61 and extends into and through the central through-hole 425 in the inner surrounding wall 451 of the coolant container 42, the central hole 411 in the hollow wall body 40 of the column unit 41, and through the mounting part 22 of the base 2 for connecting to a power source (not shown).

In operation, the coolant 200 is withdrawn from the coolant container 42 and is driven by the first coolant driving member 3 to circulate through the first and second fluid passages 412, 413 and the fluid channel 51 and then return to the coolant container 42, thereby carrying away the heat generated by the light emitting diodes and transferred to the heat sink 5, followed by transferring the heat to the column unit 41 and dissipated to the atmosphere.

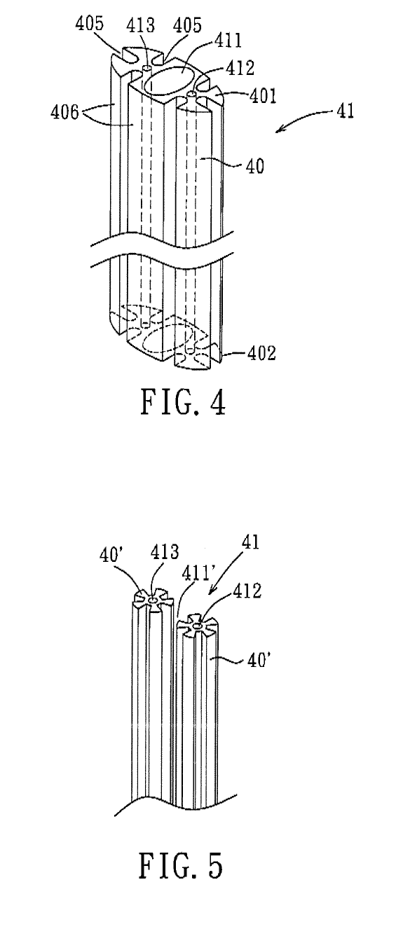

FIG. 4 illustrates the column 41 of the column unit 41 of the second preferred embodiment of the LED lamp according to this invention. The second preferred embodiment differs from the previous embodiment in that the column of the column unit 41 of the second preferred embodiment has a hollow wall body 40 that is formed with a plurality of grooves 405 extending along the length of the hollow wall body 40 between the first and second ends 401, 402 of the hollow wall body 40, and a plurality of heat dissipating fins 406 disposed alternately with the grooves 405.

FIG. 5 illustrates the column unit 41 of the third preferred embodiment of the LED lamp according to this invention. The third preferred embodiment differs from the previous embodiments in that the column unit 41 of the third preferred embodiment has first and second hollow wall bodies 40′ that are separated from each other by a gap 411′. The first and second fluid passages 412, 413 are formed in the first and second hollow wall bodies 40′, respectively.

In one modified embodiment, one of the first and second hollow wall bodies 40′ can be in the form of a straight tube or a multi-turn tube.

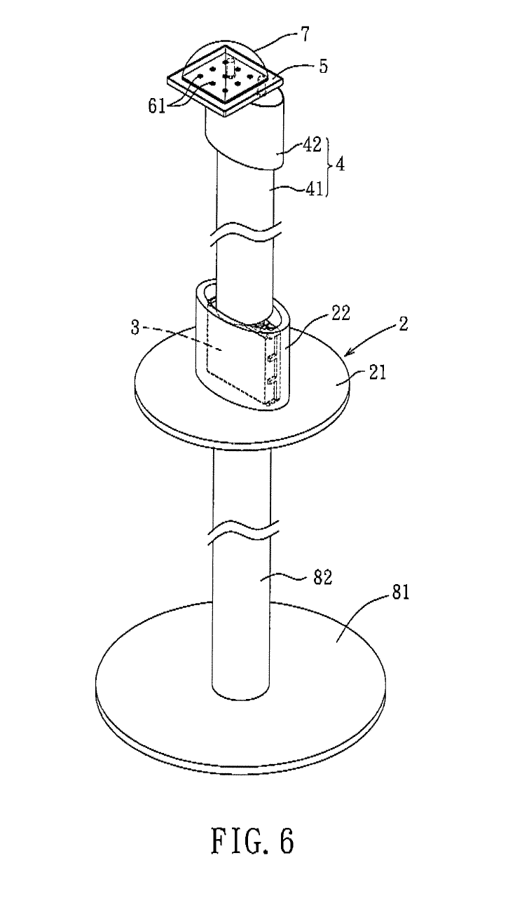

FIG. 6 illustrates the fourth preferred embodiment of the LED lamp according to this invention. The fourth preferred embodiment differs from the previous embodiments in that the heat dissipating assembly 4 of the fourth preferred embodiment further includes a second base plate 81 disposed below the first base plate 21 of the base 2, and an extension column 82 interconnecting the first and second base plates 21, 81 so as to raise the height of the light emitting diodes 61.

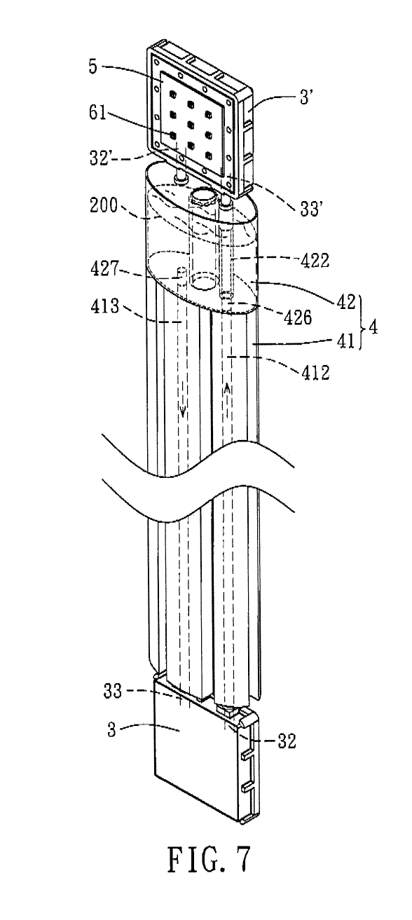

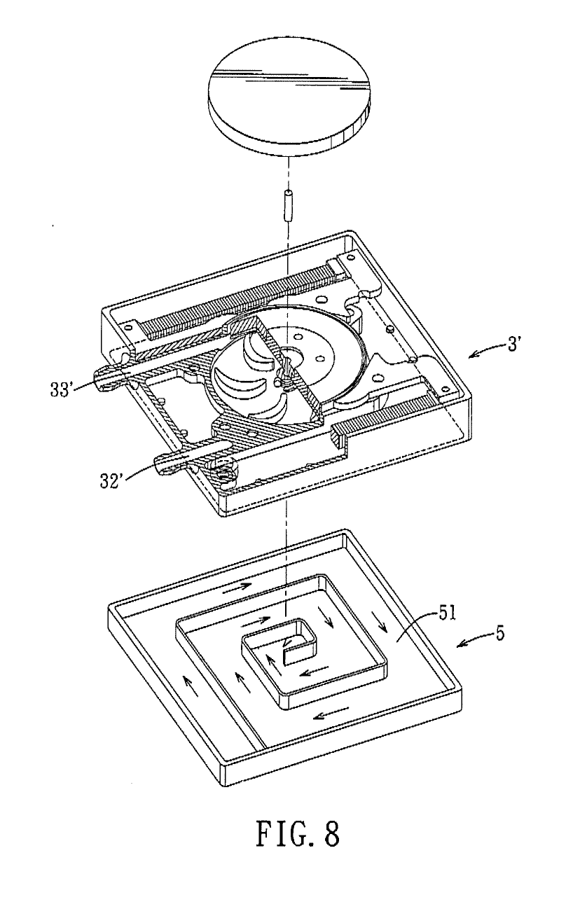

FIGS. 7 and 8 illustrate the fifth preferred embodiment of the LED lamp according to this invention. The fifth preferred embodiment differs from the previous embodiments in that the LED lamp of the fifth preferred embodiment further includes a second driving member 3′ disposed above the coolant container 42, integrally coupled to the heat sink 5, and having a suction port 33′ in fluid communication with one end of the fluid channel 51 and the connecting pipe 422, and a discharging port 32′ in fluid communication with the other end of the fluid channel 51 and the coolant container 42 so as to withdraw the coolant 200 from the coolant container 42 via the second fluid passage 413, the first coolant driving member 3, the first fluid passage 412, the connecting pipe 422 and the suction port 33′ into the fluid channel 51 and to discharge the coolant 200 from the discharging port 32′ into the coolant container 42. The design of the assembly of the heat sink 5 and the second coolant driving member 3′ (see FIG. 8) is similar to that of the centrifugal pump device disclosed in the U.S. Patent Application Publication No. 2008/0069706. Hence, the structure of the assembly of the heat sink 5 and the second coolant driving member 3′ will not be described in detail herein for the sake of brevity. The first and second coolant driving members 3, 3′ can be operated simultaneously or individually. The second coolant driving member 3′ can be used as a backup or as a booster to increase the driving force to an amount sufficient to drive circulation of the coolant 200 in the flow circulation path when the vertical height of the column unit 41 is relatively high.

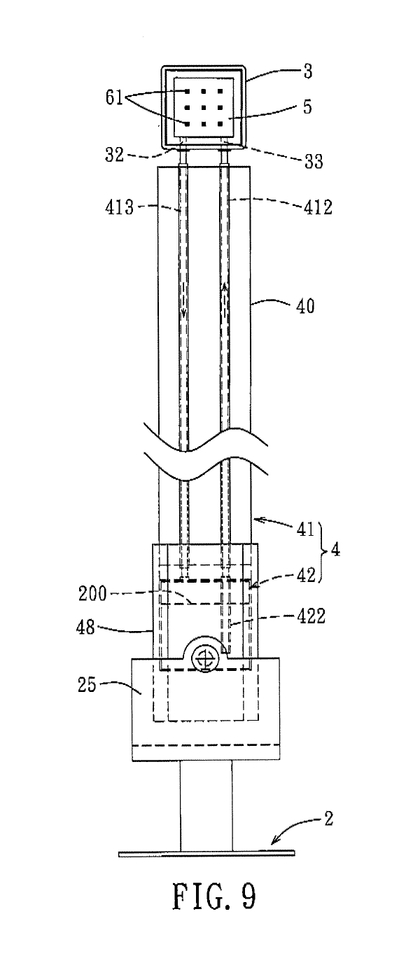

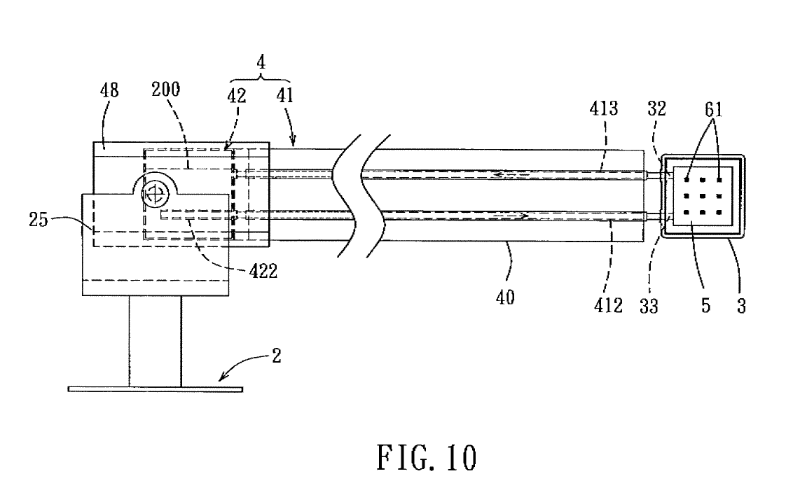

FIGS. 9 and 10 illustrate the sixth preferred embodiment of the LED lamp according to this invention. The sixth preferred embodiment differs from the previous embodiments in that the first coolant driving member 3 of the sixth preferred embodiment is integrally coupled to the heat sink 5 and has a suction port 33 and a discharging port 32 that are in direct fluid communication with two ends of the fluid channel 51, respectively, and that the column unit 41 is disposed between and is connected to the coolant container 42 and the first coolant driving member 3 in a manner that the first coolant driving member 3 withdraws the coolant 200 from the coolant container 42 via the first fluid passage 412 into the fluid channel 51 and discharges the coolant 200 from the discharging port 32 into the coolant container 42 via the second fluid passage 413. The assembly of the first coolant driving member 3 and the heat sink 5 of the sixth preferred embodiment has a structure the same as that of the assembly of the second coolant driving member 3′ and the heat sink 5 of the fifth preferred embodiment (see FIG. 8). In addition, in the sixth preferred embodiment, the base 2 is provided with a pivot seat 25. The LED lamp further includes a hollow holder body 48 pivoted to the pivot seat 25 of the base 2. The coolant container 42 is securely inserted into the hollow holder body 48 so as to permit the column unit 41 to be rotatable between a vertical position (see FIG. 9) and a horizontal position (see FIG. 10).

By forming the first and second fluid passages 412, 413 in the column unit 41 of the LED lamp of this invention for circulation of the coolant 200 therethrough, the heat dissipation of the light emitting diodes 61 can be improved. In addition, the heat sink 5 can be made without forming heat dissipating fins for increasing heat dissipation as required by the prior art, thereby enabling the LED lamp to have a lower center of gravity with increased stability.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A light emitting diode lamp comprising:
a heat dissipating assembly including a column unit and a coolant container connected to said column unit, said column unit being made from a thermally conductive material for heat dissipation and defining opposite first and second fluid passages separated from each other, said coolant container defining a coolant storing space for storing a coolant therein;
a heat sink mounted on said heat dissipating assembly and defining a fluid channel therein;
a light emitting unit including at least one light emitting diode and mounted on said heat sink so that said heat sink can carry away the heat generated from said light emitting diode; and
a first coolant driving member;
wherein said first coolant driving member, said heat sink, said coolant container and said column unit are coupled together so that said first coolant driving member drives circulation of the coolant through said first and second fluid passages, said coolant storing space and said fluid channel so as to transfer the heat from said heat sink to said column unit through the circulated coolant.

2. The light emitting diode lamp of claim 1, further comprising a power line connected to said light emitting unit, and a base, said coolant container having a central through-hole extending along a length of said coolant container, said column unit having a central hole extending along a length of said column unit, said column unit being mounted on said base, said power line passing through said heat sink, said central through-hole, said central hole, and said base.

3. The light emitting diode lamp of claim 1, wherein said column unit includes a column that has a hollow wall body having first and second ends and defining a central hole extending along the length of said hollow wall body and through said first and second ends of said hollow wall body, said first and second fluid passages being formed in said hollow wall body and extending along the length of said hollow wall body and through said first and second ends of said hollow wall body, said central hole being disposed between said first and second fluid passages.

4. The light emitting diode lamp of claim 3, wherein said hollow wall body of said column is formed with a plurality of grooves extending along the length of said hollow wall body between said first and second ends of said hollow wall body, and a plurality of heat dissipating fins disposed alternately with said grooves.

5. The light emitting diode lamp of claim 1, wherein said column unit includes first and second hollow wall bodies that are separated from each other by a gap and that are formed with said first and second fluid passages, respectively.

6. The light emitting diode lamp of claim 1, further comprising a connecting pipe, said heat sink being disposed above said column unit, said coolant container being disposed between said heat sink and said column unit, said connecting pipe extending into and through said coolant storing space and being connected directly to said fluid channel of said heat sink and said first fluid passage of said column unit.

7. The light emitting diode lamp of claim 6, wherein said first coolant driving member is disposed below said column unit and has a discharging port and a suction port both of which are in fluid communication with said first and second fluid passages, respectively, so as to withdraw the coolant from said coolant container via said second fluid passage into said suction port and to discharge the coolant from said discharging port into said fluid channel via said first fluid passage and said connecting pipe.

8. The light emitting diode lamp of claim 7, further comprising a second coolant driving member disposed above said coolant container, integrally coupled to said heat sink, and having a suction port in fluid communication with one end of said fluid channel and said connecting pipe, and a discharging port in fluid communication with the other end of said fluid channel and said coolant container.

9. The light emitting diode lamp of claim 1, wherein said first coolant driving member is integrally coupled to said heat sink and has a suction port and a discharging port that are in fluid communication with two ends of said fluid channel, respectively, said column unit being disposed between and being connected to said coolant container and said first coolant driving member, said first coolant driving member withdrawing the coolant from said coolant container via said first fluid passage into said fluid channel and discharges the coolant from said discharging port into said coolant container via said second fluid passage.

10. The light emitting diode lamp of claim 9, further comprising a base provided with a pivot seat and a hollow holder body pivoted to said pivot seat, said coolant container being securely inserted into said hollow holder body so that said column unit is rotatable between a vertical position and a horizontal position.

11. The light emitting diode lamp of claim 1, wherein said heat dissipating assembly further includes a first base plate, a second base plate disposed below said first base plate, and an extension column interconnecting said first and second base plates, said first base plate being provided with a mounting part protruding upwardly from said first base plate and defining a receiving space that receives said first coolant driving member therein.
